(19) United States
(12) Patent Application Publication
(10) Pub. No.: US 2023/0101792 A1
(43) Pub. Date: Mar. 30, 2023

(54) COMPOSITE OPTICAL FIBRE BASED PLASMA GENERATION DEVICE

(71) Applicants: UNIVERSITE DE BORDEAUX, BORDEAUX (FR); CENTRE NATIONAL DE LA RECHERCHE SCIENTIFIQUE - CNRS, PARIS (FR); INSTITUT POLYTECHNIQUE DE BORDEAUX, TALENCE (FR); UNIVERSITE DE LIMOGES, LIMOGES (FR); UNIVERSITE DE BOURGOGNE, DIJON (FR)

(72) Inventors: Sylvain DANTO, MERIGNAC (FR); Clément STRUTYNSKI, TALENCE (FR); Frédéric DESEVEDAVY, DIJON (FR); Lionel TEULEGAY, BORDEAUX (FR); Vincent COUDERC, VERNEUIL SUR VIENNE (FR); Frédéric SMEKTALA, REMILLY SUR TILLE (FR); Thierry CARDINAL, SALLES (FR)

(21) Appl. No.: 17/904,919

(22) PCT Filed: Aug. 24, 2021
(86) PCT No.: PCT/FR2021/050322

§ 371 Date: Aug. 24, 2022

(30) Foreign Application Priority Data
Feb. 25, 2020 (FR) 2001831

(51) Int. Cl. G01N 21/67; H05H 1/24

(52) U.S. Cl. CPC G01N 21/67; H05H 1/24; G01N 2201/08

(57) ABSTRACT

A device for generating a plasma and detecting a light signal. The plasma being intended to be generated in the vicinity of a study area of a sample and the light signal originating in the study area. The device including a current generator, an analysis unit, and an electrical and optical waveguide including means for transmitting an electric current configured to generate a plasma at one end of the means for transmitting the electric current in the vicinity of the study zone, means for detecting and transmitting configured to detect and transmit the light signal from the study area to the analysis unit, and an optical cladding portion, the means for transmitting the electric current and the means for detecting and transmitting the light signal being accommodated in the optical cladding portion.

### CROSS REFERENCE TO RELATED APPLICATIONS

This application is a National Stage of International Application No. PCT/FR2021/050322, having International Filing Date of 24 Feb. 2021, which designated the United States of America, and which International Application was published under PCT Article 21(2) as WO Publication No. 2021/170955 A1, which claims priority from the benefit of French Patent Application No. 2001831, filed on 25 Feb. 2020, the disclosures of which are incorporated herein by reference in their entireties.

### BACKGROUND

### Field

The present disclosure relates in general to the field of plasma generation systems.

It relates more particularly to a device equipped with an electrical and optical waveguide based on composite optical fibers allowing both the transmission of an electric current, in order to generate an electric field or a plasma in the vicinity of a study zone for the analysis of a sample, and the detection and transmission of a light signal emitted by the plasma or by said study zone excited by the electric field to an analysis unit for analyzing the light signal.

It relates in particular to a plasma spectroscopy device comprising an electrical and optical waveguide designed to generate a plasma in the vicinity of a study zone for the analysis of a sample and to detect a light signal emitted by the plasma, and to convey the light signal to an optical spectrometer for the analysis of the light spectrum of said signal.

### BRIEF DESCRIPTION OF RELATED DEVELOPMENTS

A known plasma spectroscopy technique is laser-induced plasma spectroscopy, known by its acronym LIBS. The operating principle of LIBS is illustrated in FIG. 1. It consists in focusing a light pulse delivered by a laser 2 on a sample 4 using a focusing system 8. The pulse has a duration of a few nanoseconds and an energy of a few tens of millijoules. By focusing it, when the areal energy density at the surface of the sample becomes high enough to exceed the breakdown threshold of the sample to be analyzed, the material is locally heated and then vaporized by the laser beam, which leads to the formation of a plasma 5 on the surface of the sample in the focusing region. The excited species contained in the plasma—ions, atoms or molecules—emit characteristic lines which are collected by an optical fiber 3 connected to a spectrometer 6. The spectral analysis of the spectrum collected in the UV/visible range allows qualitative and quantitative information on the composition of the sample to be extracted.

Devices of the prior art implementing the LIBS technique therefore generally comprise a system for focusing a laser beam on the sample and a system for collecting and spectroscopically analyzing the light radiation emitted by the plasma, a system for moving the optical fiber in order to adjust the sighting direction of the optical fiber for collecting the lines with respect to the plasma.

Since these devices use a light beam incident on the sample in direct sight and in free space, it is therefore not possible to carry out measurements for information from a target region of interest located in a zone that is difficult to access. The configuration of these devices therefore prevents measurements via the endoscopic route.

Another drawback of these devices is that they require the use of a sighting system to ensure alignment between the optical path of the optical fiber and the focusing zone of the incident light beam, which results in an increase their size and cost.

In order to overcome the aforementioned drawbacks of the prior art, one object of the present disclosure is a plasma-emission and light-signal-collection device that is simple and quick to implement. Another object of the present disclosure is to provide a plasma-emission and light-signal-collection device that is entirely based on optical fibers to allow easy integration into an endoscopic head in order to carry out measurements via endoscopic route, even in zones for analysis that are difficult to access.

### SUMMARY

What is proposed is a device for generating a plasma and detecting a light signal, the plasma being intended to be generated in the vicinity of a study zone of a sample and the light signal coming from said study zone, the device comprising:
a current generator;
an analysis unit;
an electrical and optical waveguide comprising means for transmitting an electric current which are configured to generate a plasma at one end of said means for transmitting electric current in the vicinity of said study zone, detection and transmission means which are configured to detect and transmit the light signal coming from said study zone to the analysis unit, and an optical cladding, said means for transmitting electric current and said means for detecting and transmitting said light signal being housed in the optical cladding.

According to a first embodiment of the disclosure, the electrical and optical waveguide comprises:
a composite fiber having a main longitudinal axis (AA′) and comprising at least two electrically conductive cores and the optical cladding, the cores being placed parallel to the longitudinal axis (AA′) and housed in the optical cladding and configured to be subjected to a difference in electrical potential in order to generate a plasma at the ends of the conductive cores in the vicinity of the study zone, and
at least one optical fiber configured to detect and transmit the light signal to the analysis unit, said optical fiber comprising at least a portion housed in said optical cladding and arranged parallel to the main longitudinal axis between the two conductive cores, the ends of the conductive cores and of the optical fiber which are intended to be placed in the vicinity of the study zone being aligned.

According to one embodiment of the disclosure, the composite fiber and the optical fiber are coaxial along the main longitudinal axis.

According to another embodiment of the disclosure, the composite fiber comprises a through-hole extending along the main longitudinal axis, a portion of said optical fiber being placed in said hole.

According to another embodiment of the disclosure, the optical fiber is a single-mode or multimode optical fiber.

According to another embodiment of the disclosure, the optical fiber is attached to the optical cladding of the composite fiber by bonding.

According to another embodiment of the disclosure, the electrical and optical waveguide comprises:
a composite optical fiber having a main longitudinal axis (AA′), said composite optical fiber comprising at least two electrically conductive cores, at least one optical core and an optical cladding, the conductive cores being placed parallel to the longitudinal axis and housed in the optical cladding and configured to be subjected to a difference in electrical potential in order to generate a plasma at the ends of the conductive cores in the vicinity of the study zone, said at least one optical core being housed in the optical cladding and configured to detect and transmit the light signal to the analysis unit.

The features disclosed in the following paragraphs may, optionally, be implemented. They may be implemented independently of one another or in combination with one another:
the optical core is made of glass chosen from among the following glasses: tellurite glass, phosphate glass, borophosphate glass, chalcogenide glass,
one end of the conductive cores is connected to the current generator by an external electrical connection,
the lateral walls of the conductive cores are connected to the current generator by an external electrical connection through a cutout in the optical cladding,
the conductive cores are made of a metallic material chosen from among the following metals: tin, a tin-based alloy,
the optical cladding is made of glass chosen from among the following glasses: tellurite glass, phosphate glass, borophosphate glass, chalcogenide glass,
the optical cladding is made of a polymer chosen from among the following polymers: polyethersulfones (PES), polysulfones (PSU), polymethyl methacrylate (PMMA).

According to one embodiment of the disclosure, the device being a device allowing plasma spectroscopic measurements, the analysis unit is an optical spectrometer for carrying out plasma spectroscopic measurements.

Another aspect of the disclosure relates to a plasma spectroscopic measurement method implementing the device defined below and when the analysis unit is an optical spectrometer, comprising the following steps:
supplying a direct current to the electrical and optical waveguide in order to generate a plasma at the ends of said waveguide in the vicinity of the study zone;
detecting a light signal emitted by the plasma via the ends of the electrical and optical waveguide;
transmitting the light signal to the spectrometer via said electrical and optical waveguide;
spectrally analyzing the light signal by means of the spectrometer.

### BRIEF DESCRIPTION OF THE DRAWINGS

Other features, details and advantages of the disclosure will become apparent from reading the detailed description hereinbelow, and from analyzing the appended drawings, in which:

FIG. 1 shows a schematic view of a plasma spectroscopy device of the prior art;

FIG. 2 shows a schematic view illustrating a plasma-generation and light-signal-detection device according to one embodiment of the disclosure;

FIG. 3 shows two images representing a front view of the proximal end of an optical and electrical waveguide of FIG. 2 with the formation of an electric arc between the proximal ends of the two electrically conductive cores when a difference in electrical potential is applied between the two cores;

FIG. 4 shows a perspective view of the optical and electrical waveguide of FIG. 2;

FIG. 5 illustrates a preform featuring a central hole and two holes as well as two metal wires before their insertion into the corresponding holes in order to obtain a composite preform;

FIG. 6 illustrates the composite preform of FIG. 5 during the fiber-drawing step and a cross-sectional view of the resulting composite fiber;

FIG. 7 illustrates the assembly of the composite fiber with a non-composite optical fiber in order to form the electrical and optical waveguide of FIG. 2;

FIG. 8 shows an intensity spectrum as a function of the wavelength of a light signal emitted by the plasma obtained with the device of FIG. 2 with the main emission lines of the species contained in the atmosphere;

FIG. 9 shows a front view of an electrical and optical waveguide formed from a composite optical fiber comprising a central optical core and four electrically conductive cores;

FIG. 10 shows a front view of an electrical and optical waveguide formed from a composite optical fiber comprising multiple optical cores surrounded by a plurality of electrically conductive cores;

FIG. 11 illustrates a composite preform featuring three holes as well as an optical capillary and two metal wires before their insertion;

FIG. 12 illustrates the composite preform of FIG. 11 during the fiber-drawing step and a cross-sectional view of the resulting composite optical fiber.

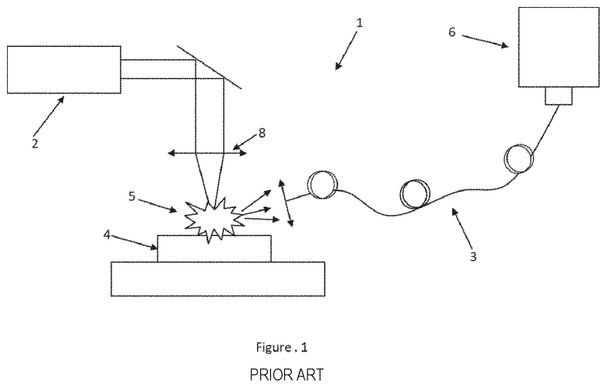

### DETAILED DESCRIPTION

The drawings and the description below contain, for the most part, elements of a certain character. Therefore, they may not only be used to better understand the present disclosure, but also contribute to its definition, where appropriate.

In order to facilitate understanding of the description, some definitions of technical terms are included below.

An optical and electrical waveguide is a waveguide that allows both a light signal and an electric current to be conducted.

A composite fiber is a cylindrical wire comprising an optical cladding surrounding at least one electrically conductive core which allows an electric current to be conducted. The optical cladding is made of glass or polymer and the core is made of metal. A coating potentially surrounds the optical cladding in order to provide mechanical strength to the composite fiber.

A composite optical fiber is a cylindrical wire comprising an optical cladding surrounding at least one electrically conductive core and at least one optical core. The optical cladding is made of glass or polymer. The electrically conductive core is made of metal. The optical core is made of glass. A coating surrounds the optical cladding in order to provide mechanical strength to the composite fiber.

An optical fiber is a cylindrical wire comprising an optical cladding surrounding at least one optical core which allows a light signal to be conducted. A coating surrounds the optical cladding in order to provide mechanical strength to the optical fiber.

Glasses have a glass transition temperature T_{g}.

Metals have a melting point Tₘ.

In the present disclosure, what is meant by proximal end is the end closest to the surface of the study zone of the sample to be analyzed, and what is meant by distal end is the end furthest from the surface of the study zone of the sample to be analyzed.

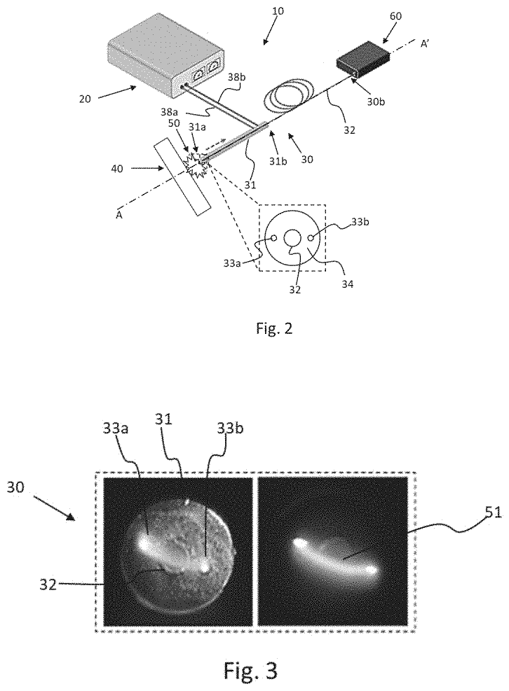

Reference is now made to FIG. 2 which illustrates a device 10 for generating plasma and detecting a light signal according to one embodiment of the disclosure. The device comprises an electrical and optical waveguide 30 connected both to a current generator 20 and to an analysis unit 60. The electrical and optical waveguide 30 comprises a proximal end which is intended to be placed in the vicinity of a study zone of a sample 40 which may be an object, a confined gaseous medium or a biological tissue.

The current generator is configured to supply a direct electric current to the waveguide in order to generate at the proximal end of the electrical and optical waveguide a plasma 50 through interaction with the sample.

The plasma emits a light signal characteristic of the sample, in a wavelength range from 300 nm to 1000 nm. The light signal is collected directly by the proximal end of the electrical and optical waveguide which transmits it to the analysis unit.

Conventionally, the sample may be positioned on a sample holder, which may be manual or motorized, allowing the sample to move, preferably in the three spatial directions. The sample may be moved with micrometer precision. It is thus possible to analyze the sample point by point. The movement of the sample is synchronized with the current generator, which leads to each injection of electric current, the ablation of the sample and vaporization of a small quantity of material to form a micro-plasma in the region of the sample to be analyzed.

In the case where the device is used as a plasma spectroscopy device as illustrated in FIG. 2, the analysis unit 60 is an optical spectrometer. Generally, an optical spectrometer comprises an entrance slit aligned with a diffraction grating, a plane mirror which reflects the diffracted light onto one or two CCD or similar type of photodetectors which allows a light spectrum to be obtained. In the exemplary embodiment described below, the spectrometer is, for example, a spectrometer allowing a spectral range from 200 nm to 1100 nm to be covered.

According to a first embodiment, the electrical and optical waveguide 30 comprises a composite fiber 31 and an optical fiber 32 which is separate from the composite fiber. The composite fiber 31 comprises two conductive cores 33a, 33b which are configured for the transmission of an electric current from the distal end 31b of the composite fiber to a proximal end 31a of the composite fiber for the generation of the plasma 50 in the vicinity of the study zone of the sample. The cores are surrounded by an optical cladding 34 of the composite fiber. The optical fiber 32 is configured for the detection and transmission of a light signal emitted by the plasma from the proximal end of the composite fiber to the optical spectrometer. The optical fiber 32 is housed in a longitudinal hole along the main axis of the composite fiber such that the optical cladding also surrounds the optical fiber. Furthermore, a proximal end of the optical fiber 32 is aligned with the proximal end of the conductive cores.

With reference to FIG. 3, when a direct current is injected into the conductive cores via the current generator, an electric arc 51 is generated between the proximal ends of the two conductive cores 33a, 33b. By virtue of the specific arrangement of the optical fiber 32 and the conductive cores 33a, 33b in the optical cladding, the electric arc generated passes in front of the proximal end of the optical fiber. In other words, the electric arc is also produced in the vicinity the proximal end of the optical fiber.

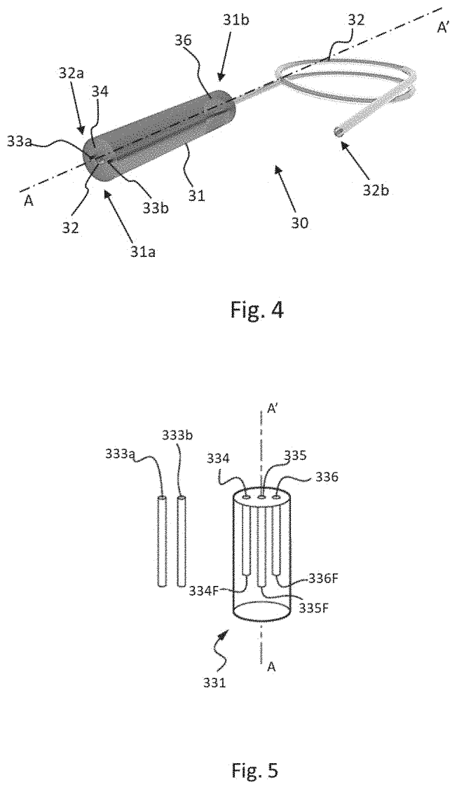

With reference to FIG. 4, the optical and electrical waveguide 30 of FIG. 2 is described in more detail below. It comprises a composite fiber 31 and an optical fiber 32 having a portion housed in the optical cladding of the composite fiber 31. The composite fiber 31 is a cylindrical wire extending along the main longitudinal axis AA′. It has a proximal end 31a and a distal end 31b. The proximal end 31a is intended to be placed in the vicinity of a study zone of a sample during the operation of the device. The composite fiber comprises an optical cladding 34 in which are housed two conductive cores 33a, 33b. The two conductive cores are arranged parallel to the main axis. The optical cladding 34 of the composite fiber also comprises a through-hole 35 which extends along the main axis (FIG. 7). A portion of the optical fiber 32 is housed in the through-hole. This portion of the optical fiber is arranged in the optical cladding along the main axis AA′ between the two conductive cores 33a, 33b. The optical fiber 32 also has a proximal end 32a and a distal end 32b. Preferably, the portion of the optical fiber housed in the optical cladding and the composite fiber are coaxial along the main axis. Furthermore, the proximal end 32a of the optical fiber and the proximal end 31a of the composite fiber are aligned in the same cross-sectional plane. By virtue of this particularly advantageous configuration, the proximal end 32a of the optical fiber which has the function of collecting the light signal is placed between the proximal ends of the conductive cores which generate the plasma. The sight of the optical fiber therefore passes directly through the center of the plasma. Such a configuration allows the optical fiber to collect the maximum light signal from the plasma.

To ensure the stability of the optical fiber in the optical cladding of the composite fiber, the optical fiber is attached to the optical cladding of the composite fiber by bonding at both ends of the composite fiber.

The conductive cores 33a, 33b are each connected to the current generator by external electrical connections 38a, 38b as shown in FIG. 2. These connections 38a, 38b are formed, for example, by copper wires.

FIGS. 2 and 4 illustrate one example of external electrical connection, called lateral connection, in which the end of the copper wire is connected to a zone of the metal wall of the conductive core, close to the distal end of the conductive core. To reach the metal wall of the conductive core, a cutout 36 with a size of 0.1 mm² is made in the wall of the optical cladding. The copper wire is inserted through the cutout and is then bonded or laser welded to the metal wall of the conductive core. The two electrical contacts are therefore each positioned on one side of the composite fiber. This lateral external electrical connection allows the electrical connections of the two conductive cores to be spatially isolated.

According to another example (not illustrated), the distal ends of the conductive cores are connected to the copper wires by soldering or by bonding. In this case, the distal ends of the conductive cores are outside the optical cladding in order to be connected to the current generator by the electrical connections.

FIGS. 5 to 7 illustrate the three main steps in the production of an electrical and optical waveguide of FIG. 4. The method comprises a first step of obtaining a composite preform 331, a second step of producing a composite fiber 31 and a third step of assembling a composite fiber 31 and an optical fiber 32 together in order to obtain the electrical and optical waveguide.

In the step of obtaining a composite preform, first obtained is a solid preform having a cylindrical shape of circular section, extending over a length of several centimeters along a longitudinal axis AA′. The preform has, for example, a length of a few centimeters and a diameter of the order of a centimeter. The preform may, for example, have a length of 75 mm and bases with a diameter of 19 mm. A plurality of openings are drilled into the base of the solid preform. The drilling is, for example, performed mechanically or by laser. For example, a first, central blind hole 335 with a diameter of 5 mm is drilled in the center of the first base of the preform. This first central hole has a bottom 335F. Next, two other blind holes 334, 336 with a diameter of 1.5 mm are drilled, placed symmetrically on either side of the first, central blind hole, the two other holes having bottoms 334F, 336F, respectively. The two metal wires 333a, 333b are then inserted into each of the blind holes 334, 336. A composite preform 331 with a central hole 335 is obtained.

The metal wires are, for example, made of a metal such as tin, or a tin-based alloy such as tin-gold or tin-silver. Preferably, the metals chosen have a low melting point Tₘ. The preform is made of polymer or of glass. The preform according to the present disclosure comprises a glass with a low T_{g}, for example a chalcogenide glass, a tellurite glass, a fluoride glass or a phosphate glass. The materials of the preform and of the metal wires are chosen so as to allow co-fiber-drawing. The fiber-drawing temperature T_{f} is higher than the glass transition temperature T_{g} and the metal melting point Tₘ.

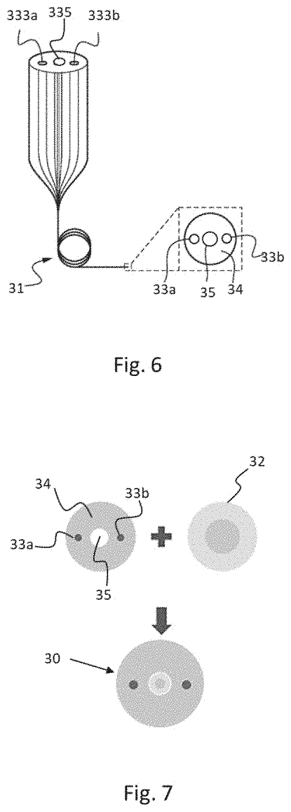

In the fiber-drawing step as illustrated in FIG. 6, the preform is placed in an oven to reach the fiber-drawing temperature of the preform T_{f}. It is, for example, between 300° C. and 600° C., and is chosen to be higher than the glass transition temperature of the preform and the melting point of the metals. Under the effect of the fiber-drawing temperature T_{f}, the preform becomes viscous and the metal wire becomes liquid. The composite preform is homothetically drawn and thinned to form a composite fiber 31. Homothetic drawing allows the geometry of the composite preform to be preserved. On completion of this step, what is obtained is a composite fiber 31 several meters long and comprising two conductive cores 33a, 33b embedded in the optical cladding of the fiber and a central hole 35.

The average diameter of the fiber is generally between 500 μm and 1 mm. The diameter of the central hole is, for example, 150 μm. The diameter of the conductive cores is, for example, of the order of 50 μm. The size of the central hole is designed so that most commercially available optical fibers may be inserted therein. The two electrical cores are, for example, spaced apart by a distance of the order of 300 μm.

With the solid preform and the two metal wires being drawn simultaneously, the conductive cores 33a, 33b are completely embedded in the optical cladding of the composite fiber. In other words, the conductive cores are fully in contact with the optical cladding of the fiber along the composite fiber.

In the step of assembling the composite fiber and the optical fiber together in order to form the electrical and optical waveguide 30, a portion of the composite fiber of about 5 cm, for example, is selected and the optical fiber 32 is inserted into the through-hole 35 in the composite fiber. At one end of the waveguide which is intended to form the proximal end of the waveguide, the end of the composite fiber, the end of the conductive cores and the end of the optical fiber are aligned, i.e. located in the same plane in a cross section. To ensure the stability of the optical fiber in the hole in the optical cladding, an epoxy resin is applied, for example, to the ends of the composite fiber at the location of the hole in order to attach the optical fiber to the optical cladding of the composite fiber.

On completion of this assembly step, what is obtained is an electrical and optical waveguide 30 comprising two conductive cores 33a, 33b embedded in the optical cladding 34 of the composite fiber and an optical fiber 32 housed in a hole in the optical cladding 34. The two conductive cores are used as electrodes to conduct an electric current in order to generate a plasma at the proximal end of the waveguide, and the optical fiber is used to collect and transmit a light signal emitted by the plasma to the analysis unit which is, for example, a spectrometer.

By virtue of the use of such an electrical and optical waveguide, it is no longer necessary to adjust the position of the optical fiber so that the line of sight of the fiber passes through the center of the overall plasma emission. The optimal position for the optical fiber is achieved automatically during the production of the electrical and optical waveguide. Specifically, the conductive cores are placed on either side of the optical fiber in the optical cladding such that when a difference in electric potential is applied between the electrical cores, the electric arc formed between the proximal ends of the conductive cores passes in front of the detection proximal end of the optical fiber as shown in FIG. 3.

Now described is a method for the spectroscopic measurement of a plasma generated in ambient air by means of the plasma spectroscopy device of FIG. 2. The atmosphere has been enriched with argon, nitrogen and oxygen.

In this example, the optical cladding of the composite fiber is made of polyethersulfone (PES) whose glass transition temperature is around 225° C. The two conductive cores are here two electrodes made of tin whose melting point is around 232° C., which is compatible with the fiber-drawing temperature. The diameter of the optical cladding is 620 μm. The diameter of the two conductive cores is 50 μm. The optical fiber is a multimode optical fiber made of silica with a numerical aperture of 0.22. The spectrometer is a fiber-optic spectrometer which covers a spectral range between 200-1100 nm. A direct current of 0.2 mA is applied to generate the plasma.

In a first step of the plasma spectroscopic measurement method of the disclosure, the proximal end of the electrical and optical waveguide 30 is placed in the vicinity of the study zone. It is in this study zone that it is sought to determine the presence of chemical compounds.

In a second step, a direct current of 0.2 mA is supplied to the conductive cores of the waveguide in order to generate a plasma at the end of the waveguide through interaction between the electric field and the medium. Species in the study zone excited by the plasma emit a light signal.

In a third step, the light signal is then collected by the proximal end of the optical fiber of the electrical and optical waveguide and transmitted to the spectrometer for analysis thereof.

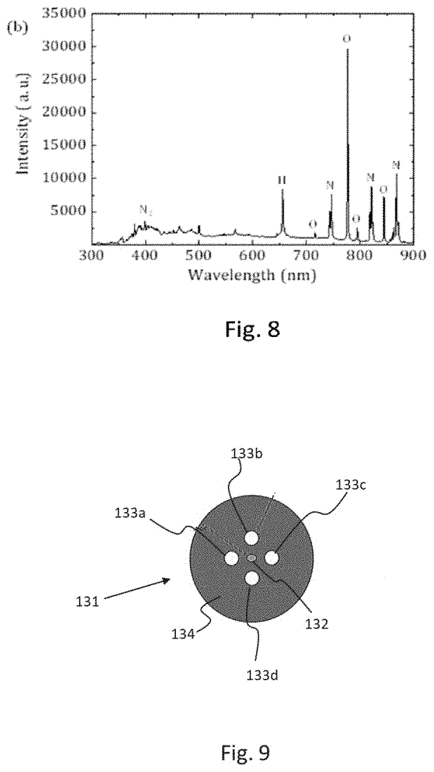

FIG. 8 shows the curve representing the light signal delivered by the spectrometer's processing means. On the curve, the X-axis gives the wavelength of the spectrum, and Y-axis gives the value, in arbitrary units, of the intensity of the light signal.

Referenced on the curve are the various characteristic wavelengths for which the intensity exhibits a maximum, or a “peak”. Depending on the position of the characteristic wavelengths in the measured light spectrum, it is possible to identify, in a known manner, which species have been detected in the study zone. The curve of FIG. 8 shows, for example, peaks characteristic of argon, nitrogen, oxygen and hydrogen between 650 nm and 900 nm.

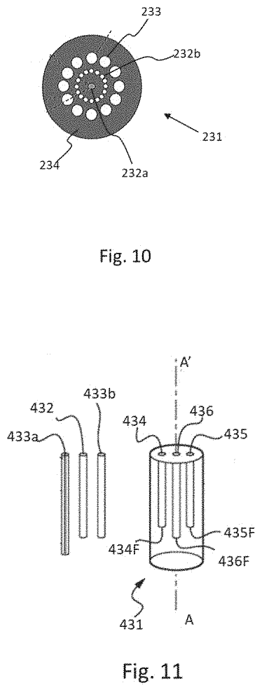

FIGS. 9 and 10 illustrate a second embodiment of the electrical and optical waveguide used in the device of FIG. 2. The electrical and optical waveguide comprises a composite optical fiber comprising an optical cladding in which are embedded at least two electrically conductive cores for the transmission of electric current and at least one optical core for the transmission of a light signal.

The connections from this electrical and optical waveguide to the current generator and to the analysis unit, such as the optical spectrometer, are similar to the first embodiment of FIG. 2.

The electrical connection of such a waveguide is made via a lateral connection in which the end of the copper wire is connected to a zone of the metal wall of the conductive core, through a cutout made in the optical cladding.

According to a first variant illustrated in FIG. 9, the composite optical fiber comprises four conductive cores 133a, 133b, 133c, 133d distributed symmetrically around a single central optical core 132. Preferably, the central optical core is an asymmetric core in order to be able to maintain polarization of the optical wave along its propagation through the core.

According to another variant illustrated in FIG. 10, the composite optical fiber comprises a plurality of conductive cores 233 distributed symmetrically around a plurality of optical cores 232a, 232b which are independent or coupled together. FIG. 10 illustrates one exemplary configuration of the optical cores comprising a central core and a plurality of cores arranged around the central core.

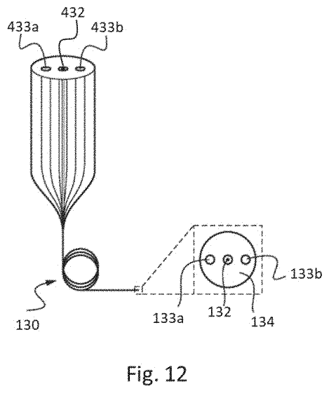

The method for producing the composite optical fiber will be described below with reference to FIGS. 11 and 12. A more detailed description is given in document FR3064076.

The method comprises a first step of obtaining a composite preform 431 and a second step of producing a composite optical fiber 130.

In the step of obtaining a composite optical preform, first obtained is a solid preform having a cylindrical shape of circular section, extending over a length of several centimeters along a longitudinal axis AA′. The preform has, for example, a length of a few centimeters and a diameter of the order of a centimeter. The preform may, for example, have a length of 75 mm and bases with a diameter of 19 mm. A plurality of openings are drilled into the base of the solid preform. The drilling is, for example, performed mechanically or by laser. For example, a first, central blind hole 436 is drilled in the center of the first base of the preform with a diameter of 5 mm with a bottom 436F, and two other blind holes 434, 435 with a diameter of 1.5 mm are placed symmetrically on either side of the first, central blind hole with bottoms 434F, 435F. An optical capillary 432 is then inserted into the central hole and a metal wire 433a, 433b is inserted into each of the two other blind holes. A composite preform 431 is obtained.

The metal wires are, for example, made of a metal such as tin, or a tin-based alloy such as tin-gold. The preform is made of polymer or of glass. The materials of the preform and of the metal wires are chosen so as to allow co-fiber-drawing.

The capillary is, for example, made of glass having a single refractive index which is higher than the refractive index of the preform. The glass capillary comprises a central part and an external part which have different refractive indices, allowing light to be guided by total internal reflection.

In the fiber-drawing step as illustrated in FIG. 12, the composite preform is placed in an oven to reach the fiber-drawing temperature of the preform T_{f}. It is, for example, between 300° C. and 600° C., and is chosen to be higher than the glass transition temperature of the preform, that of the capillary and the melting point of the metals. Under the effect of the fiber-drawing temperature T_{f}, the composite preform and the capillary become viscous and the metal wire becomes liquid. The optical composite preform is homothetically drawn and thinned to form a composite optical fiber. Homothetic drawing allows the geometry of the composite preform to be preserved. On completion of this step, what is obtained is, for example, a composite optical fiber 130 several meters long comprising an optical core 132 and conductive cores 133a, 133b housed in the optical cladding 134 of the fiber.

The average diameter of the composite optical fiber 130 is generally between 500 μm and 1 mm. The diameter of the conductive cores is, for example, of the order of 50 μm. The diameter of the optical core 132 is, for example, 150 μm. The two electrical cores are, for example, spaced apart by a distance of the order of 300 μm.

With the solid preform, the capillary and the two metal wires being drawn simultaneously, the conductive cores 133a, 133b and the optical core 132 are completely embedded in the optical cladding 134 of the composite optical fiber.

A variety of electrical and optical waveguides comprising a plurality of optical cores made of glass and a plurality of conductive cores may be used in the plasma-emission and light-signal-detection device of the present disclosure.

### INDUSTRIAL APPLICATION

The device of the disclosure is compact and has a reduced production cost. By virtue of the use of a compact fiber-optic electrical and optical waveguide, the device of the disclosure is used in an endoscopic version for the analysis of a zone that is difficult to access. The disclosure is thus applicable to various technological fields. In industry, the device of the present disclosure may be used to monitor the chemical composition of a confined or dangerous gaseous medium, or of various objects. In the field of health, the device of the disclosure may be used, for example, for in-vivo biological tissue analysis applications, as well as for tissue electrostimulation via the endoscopic route. Specifically, a new type of therapeutic endoscopic device allowing in-situ stimulation, diagnosis and/or manipulation of tissues may be envisaged by virtue of the fully fiber-optic compact electrical and optical waveguide. The implementation of combined electrical and optical functionality within the fibers proposed here is apparent as a solution to achieving this objective. Such tools could be used, for example, to deliver light excitation to a zone of interest while probing the electrochemical response of cells or, conversely, to image the fluorescence response of labeled cells to local electrical stimuli.

What is claimed is:

1. A device for generating a plasma and detecting a light signal, the plasma being intended to be generated in the vicinity of a study zone of a sample and the light signal coming from said study zone, the device comprising:
a current generator;
an analysis unit;
an electrical and optical waveguide comprising means for transmitting an electric current which are configured to generate a plasma at one end of said means for transmitting electric current in the vicinity of said study zone, detection and transmission means which are configured to detect and transmit said light signal coming from said study zone to the analysis unit, and an optical cladding, said means for transmitting electric current and said means for detecting and transmitting said light signal being housed in the optical cladding.

2. The device as claimed in claim 1, wherein the electrical and optical waveguide comprises:
a composite fiber having a main longitudinal axis and comprising at least two electrically conductive cores and the optical cladding, the cores being placed parallel to the longitudinal axis and housed in the optical cladding and configured to be subjected to a difference in electrical potential in order to generate a plasma at the ends of the conductive cores in the vicinity of the study zone, and
at least one optical fiber configured to detect and transmit the light signal to the analysis unit, said optical fiber comprising at least a portion housed in said optical cladding and arranged parallel to the main longitudinal axis between the two conductive cores, the ends of the conductive cores and of the optical fiber which are intended to be placed in the vicinity of the study zone being aligned.

3. The device as claimed in claim 2, wherein the composite fiber and the optical fiber are coaxial along the main longitudinal axis.

4. The device as claimed in claim 2, wherein said composite fiber comprises a through-hole (35) extending along the main longitudinal axis, a portion of said optical fiber being placed in said hole.

5. The device as claimed in claim 2, wherein the optical fiber is a single-mode or multimode optical fiber.

6. The device as claimed in claim 2, wherein the optical fiber is attached to the optical cladding of the composite fiber by bonding.

7. The device as claimed in claim 1, wherein the electrical and optical waveguide comprises:
a composite optical fiber having a main longitudinal axis, said composite optical fiber comprising at least two electrically conductive cores, at least one optical core and an optical cladding, the conductive cores being placed parallel to the longitudinal axis and housed in the optical cladding and configured to be subjected to a difference in electrical potential in order to generate a plasma at the ends of the conductive cores in the vicinity of the study zone, said at least one optical core being housed in the optical cladding and configured to detect and transmit the light signal to the analysis unit.

8. The device as claimed in claim 7, wherein the optical core is made of glass chosen from among the following glasses: tellurite glass, phosphate glass, borophosphate glass, chalcogenide glass.

9. The device as claimed in claim 2, wherein one end of the conductive cores is connected to the current generator by an external electrical connection.

10. The device as claimed in claim 2, wherein the lateral walls of the conductive cores are connected to the current generator by an external electrical connection through a cutout in the optical cladding.

11. The device as claimed in claim 2, wherein the conductive cores are made of a metallic material chosen from among the following metals: tin, a tin-based alloy.

12. The device as claimed in claim 1, wherein the optical cladding is made of glass chosen from among the following glasses: tellurite glass, phosphate glass, borophosphate glass, chalcogenide glass.

13. The device as claimed in claim 1, wherein the optical cladding is made of a polymer chosen from among the following polymers: polyethersulfones, polysulfones, polymethyl methacrylate.

14. The device as claimed in claim 1 being a device allowing plasma spectroscopic measurements, wherein the analysis unit is an optical spectrometer for carrying out plasma spectroscopic measurements.

15. A plasma spectroscopic measurement method implementing the device as claimed in claim 14, comprising the following steps:
supplying a direct current to the electrical and optical waveguide in order to generate a plasma at the ends of said waveguide in the vicinity of the study zone;
detecting a light signal emitted by the plasma via the ends of the electrical and optical waveguide;
transmitting the light signal to the spectrometer via said electrical and optical waveguide;
spectrally analyzing the light signal by means of the spectrometer.
